(19) United States
(12) Patent Application Publication
(10) Pub. No.: US 2004/0098405 A1
(43) Pub. Date: May 20, 2004

(54) System and Method for Automated Link Analysis

(76) Inventors: Michael Zrubek, Granger, TX (US); Charles Moon, Round Rock, TX (US); Michael Shultz, Austin, TX (US)

Correspondence Address: TAYLOR RUSSELL & RUSSELL, P.C., 4807 SPICEWOOD SPRINGS ROAD, BUILDING ONE, SUITE 1200, AUSTIN, TX, 78759, US

(21) Appl. No.: 10/707,017

(22) Filed: Nov. 14, 2003

Related U.S. Application Data
(60) Provisional application No. 60/427,110, filed on Nov. 16, 2002.

(51) Int. Cl. G06F 17/00

(52) U.S. Cl. 707/103 R

(57) ABSTRACT

The invention relates to transactional analysis for identifying obvious and nonobvious relationships between target database documents and source database documents. It is particularly applicable to processes for searching, analyzing and operating on transactional and historical data found in remote and disparate databases for uncovering non-obvious or fuzzy relationships between people, places and events, and finding links and dependencies that would not otherwise be identifiable within a set of data. It is a software system and method comprising receiving an autolink command by a link analysis server from an application program, accessing a processing profile identified in the autolink command, accessing source and target document data identified in the autolink command, performing a link analysis for identifying relationships based on comparing similarity scores between target and source documents, sending a response containing a link analysis result to the application program, and saving the link analysis result in a persistence database.

### CROSS REFERENCE TO RELATED APPLICATIONS

This application claims benefit of U.S. Provisional Application No. 60/427,110, filed on Nov. 16, 2002.

### BACKGROUND OF INVENTION

The invention relates generally to means for near real-time decision analysis support through processing large amounts of stored data for obtaining useful knowledge necessary to achieve goals of an enterprise. More particularly, the invention relates to a software solution that allows for transactional relationship analysis of over thousands of records per second for identifying obvious and non-obvious relationships between target and source database documents. Applications according to the present invention include insurance claims evaluation for detection and prevention of insurance fraud in insurance claims processing, transaction risk detection, identification and verification for use in credit card processing and airline passenger screening, records keeping verification, systems that support alias identification, identity verification, government list comparisons and various government application. Although the invention may operate in a stand-alone configuration in concert with one or more similarity search engines, it is also applicable to an enterprise level solution of large-scale workflow processes. It is particularly applicable to processes for searching, analyzing and operating on transactional and historical data found in remote and disparate databases for uncovering non-obvious or fuzzy relationships between people, places and events, and providing the results in an operational environment to other enterprise applications. For example, the present invention may be treated as a plug-in application for determining linkages between database documents in an enterprise level workflow process described in U.S. patent application Ser. No. 10/673,911, filed on Sep. 29, 2003.

The present invention has capabilities to identify relationships within data beyond single-record comparisons, using similarity and exact scoring methods. This capability is very useful in finding links and dependencies that would not otherwise be identifiable within a set of data. It consists of multiple components. At the heart of the system is the Link Analysis Engine, a high-speed system that finds the relationships within and between data that may be located in multiple, remote, disparate databases. Surrounding this is an application layer, defining and containing user interface and other client applications that use the Link Analysis Engine.

When attempting to identify, detect, or investigate maleficent acts such as potential security threats or fraudulent claims activities, businesses and governmental entities face a number of problems. These include finding

Is an individual who he/she claims to be?

Is the individual a known terrorist or perpetrator of fraud?

Is the individual associated with a known criminal/terrorist/fraudulent group via a non-obvious relationship? and

Does the individual exhibit fraudulent/threatening behavioral patterns?

Previously, organizations have employed labor-intensive manual processes to answer these questions. Typically, the process took place only after a fraudulent or threatening event had already occurred, resulting in a substantial number of threats and frauds that escaped detection due to the limited availability of trained investigators. Efforts to automate the process have been difficult and ineffective as previous commercial software solutions have been unable to resolve the ambiguities and falsifications that afflict data.

Organizations previously concerned with potential maleficent acts such as threats or frauds have employed workflows requiring human decision makers to evaluate input documents and steer them through the classification process. Commercial offerings for automating workflows were primarily designed for essentially closed, internal processes such as Customer Relationship Management (CRM) and have proven unworkable when the data is flawed, fuzzy or fraudulent. Investigative units rely on highly trained, seasoned personnel to identify possible threats or frauds, but such groups have limited capacity and can afford to pursue only the highest profile cases.

There is a need for means to identify and resolve a fraudulent or threatening event prior to its occurrence and to address the problems listed above. To accomplish this, a process must utilize investigative methodologies including but not limited to the following:

Identity verification;

Intelligent watch list matching;

Non-obvious relationship linking; and

Pattern or behavior modeling.

A process to accomplish these objectives must combine the efficiency of automated processes in the front-end with the judgment of trained investigators in a hybrid classification workflow. The process must provide a fast and automated methodology for detecting and identifying maleficent activities such as threats or fraudulent behavior prior to an event occurring. It must also streamline an otherwise labor intensive, manual process.

A key requirement for such a process includes an ability to quickly and automatically establish fuzzy or non-obvious linking relationships between various documents or document attributes found in remote and disparate databases. Through further examination of these linking relationships by skilled investigators, it is possible to identify and detect maleficent activities such as threats and fraud before they occur rather than afterwards, so that remediation and investigation activities can take place to prevent the occurrence of fraud and/or threat at an early stage. Also required is an ability to perform the linking analysis functions in real time or near-real time while processing significantly large transaction datasets. The solution must enable organizations to fully utilize the knowledge stored in multiple, disparate, remote databases without the necessity to warehouse the data of interest.

An automated link analysis engine for detecting fuzzy relationships must be capable of comparing one or more input or source documents against one or more target documents in a stand-alone server configuration in cooperation with one or more similarity search engines, and may be initiated from other cooperating applications. At least three levels of linking analysis are required, including a single document against many documents, multiple documents against multiple documents in different groups, and comparison of documents within a group with each other. A desirable feature is the ability to graphically chart the fuzzy linkages between the various documents, with an ability to display a degree of fuzziness or similarity between documents.

### SUMMARY OF INVENTION

The present software system and method provides an automated link analysis engine having an ability to quickly and automatically establish fuzzy or non-obvious linking relationships between various documents or document attributes found in multiple, remote and disparate databases. It provides an ability to identify and detect maleficent activities such as threats and fraud before they occur rather than afterwards, providing an opportunity for remediation and investigation activities to prevent the occurrence of fraud and/or threat at an early stage. The link analysis engine functions in real time or near-real time while processing significantly large transaction datasets. It enables organizations to fully utilize the knowledge stored in multiple, disparate, remote databases without the necessity to warehouse the data of interest.

The automated link analysis engine provides the capability of comparing one or more input or source documents against one or more target documents in a stand-alone server configuration in cooperation with one or more similarity search engines, and may be initiated from other cooperating applications. At least three levels of linking analysis are provided, including a single document against many documents, multiple documents against multiple documents in different groups, and comparison of documents within a group with each other. It provides an ability to graphically chart the fuzzy linkages between the various documents, including displaying numerical indication of a degree of fuzziness or similarity between documents.

The automated link analysis engine sends search requests to a similarity search server, which may rely on remote similarity search agents located in multiple, remote, disparate databases to determine similarity scores between target and source documents in the remote databases. It is only necessary for the remote similarity search agents to return requested similarity scores to the similarity search server, without the need to transmit the applicable target and source documents. The requested similarity scores are then returned to the automated link analysis engine for processing. Reliance on the remote similarity search agents provides an extremely fast, near real-time processing. The similarity search server that makes use of remote similarity search agents is disclosed in U.S. patent application Ser. No. 10/653,690, filed on Sep. 2, 2003, and incorporated herein by reference.

The automated link analysis engine comprises a command interface, a data manager, an analysis engine manager, an analysis engine core and data persistence. The command interface defines a communication protocol used to communicate between the link analysis engine and other cooperating user applications, such as a graphical user interface or other cooperating applications. The command interface may accept a processing profile or a complete set of processing parameters, and provides results from the link analysis engine to the requesting user application. The commands and data supplied to the command interface may originate from local command line entry, a user interface client or may be originated from another application. The data manager handles data between the command interface, the analysis engine manager and an external similarity search server. The analysis engine manager manages all data into and from the analysis engine core. The data persistence provides a capability for storing requested results data in an external database.

The analysis process within the link analysis engine is very computationally intensive. Data records have to be accessed and fields within the records must be extracted and then compared. The overhead of just accessing the data values may have a significant impact on performance. Preprocessing and efficient structuring of the source and target data is required to achieve optimal analysis performance, while some time is incurred in the preprocessing steps.

Within the context of the present invention, the term “source data” refers to a set of input data records that is being compared with “target data”. Target data is data that each source data record is being compared to. The set of source data may be the target data itself, if data is being compared to itself. In addition, the term “document” refers to a record of data, such as an insurance claim. The data may exist in disparate databases or tables. However, once obtained by a similarity search server that provides data to a link analysis engine, the data is contained in a single structured XML document. Documents have a primary “key” or other value that uniquely identifies the data. In the present context, the term “key” or “primary key” refers to this unique identifier of a document.

An embodiment of the present invention is a software method in a computer system for automatically analyzing relationships between target and source documents, comprising the steps of receiving an autolink command by a link analysis server from an application program, accessing a processing profile identified in the autolink command, accessing source and target document data identified in the autolink command, performing a link analysis for identifying relationships based on comparing similarity scores between target and source documents and sending a response containing a link analysis result to the application program. The step of receiving may comprise receiving an autolink command by a link analysis server from a user interface connected to the link analysis server. The step of accessing a processing profile may further comprise identifying an options element, identifying a threshold limit element defining a path to threshold limit values, identifying a mapping element for defining mappings between source and target document data, identifying an output element for defining output attributes including detail level 1, detail level 2, detail level 3, detail level 4, persistence level 1, persistence level 2, persistence level 3, and persistence level 4, and identifying a datasource element for defining a persistence data source. The step of identifying an options element may further comprise specifying a stop-on-count attribute, specifying an analysis-type attribute, including single, multiple and group values, specifying a count-type attribute, including match-count, statistical and threshold, specifying a minimum and maximum number of document links to be found, specifying threshold limits for defining ranges of similarity scores for indicating linked relationships, including attributes greater-than, greater-than-and-equal-to, less-than, less-than-and-equal-to, equal-to, and not-equal-to, and specifying scoring aggregation options, including attributes include-minimum, include-maximum, and average-top-N-scores. The step of accessing a processing profile may comprise accessing a processing profile embedded inline in the autolink command. The step of accessing a processing profile may comprise accessing a processing profile from a persistence database. The source document data may comprise an inline designation attribute, one or more source document key attributes, a no-source attribute for indicating target documents are compared to each other, a query attribute, a database attribute, a cache designation attribute, and a block size attribute. The step of accessing source document data may comprise accessing source document data embedded inline in the autolink command. The step of accessing source document data may comprise accessing source document data from a similarity search server by issuing a query command to the similarity search server from the link analysis server. The target document data may comprise an inline designation attribute, one or more source document key attributes, a query attribute, a database attribute, a cache designation attribute, and a block size attribute. The step of accessing target document data may comprise accessing target document data embedded inline in the autolink command. The step of accessing target document data may comprise accessing target document data from a similarity search server by issuing a query command to the similarity search server from the link analysis server. The step of performing a link analysis for identifying relationships may be based on a comparison selected from the group consisting of comparing one source document with many target documents, comparing multiple source documents with multiple target documents in different groups, and comparing multiple documents within a group with each other. The step of sending a response may be selected from the group consisting of sending a response containing an error message, sending a response containing a count of link matches, sending a response containing a count of link matches and source documents, sending a response containing a count of link matches, source documents and document scores that were used in a link match result, and sending a response containing a count of link matches, source documents, document scores and document attribute scores that were used in a link match result. The method may further comprise the step of storing the response containing the link analysis result in a persistence database. The present invention may be a computer-readable medium containing instructions for controlling a computer system according to the software method disclosed above.

Another embodiment of the present invention is a software system for automatically analyzing relationships between target and source documents, comprising means for receiving an autolink command by a link analysis server from an application program, means for accessing a processing profile identified in the autolink command, means for accessing source and target document data identified in the autolink command, means for performing a link analysis for identifying relationships based on similarity scores between target and source documents, and means for sending a response containing a link analysis result to the application program. The application program may be a user interface connected to the link analysis server. The autolink command may comprise an embedded inline processing profile, embedded inline source document data and embedded inline target document data. The processing profile may be accessed from a persistence database. The source document data may be accessed from a similarity search server. The target data may be accessed from a similarity search server. The processing profile may comprise an options element, a threshold element, a mapping element and an output element for designating a persistence database. The means for receiving an autolink command may comprise an input processing section of the link analysis server. The means for accessing the processing profile, the source document data and the target document data may comprise a data manager section of the link analysis server. The means for performing a link analysis may comprise an engine manager section containing an engine core within the link analysis section. The means for sending a response may be an output section of the link analysis server. The system may further comprise a data persistence section of the link analysis server for storing response results.

Yet another embodiment of the present invention is a software method in a computer system for automatically analyzing relationships between target and source documents, comprising the steps of receiving an autolink command by a link analysis server from a requesting application designating a processing profile, target documents and source documents, accessing the processing profile from a database, accessing similarity scores between attributes of the target documents and attributes of the source documents from a similarity search server, linking target document attributes and source document attributes within the link analysis server based on comparative values of attribute similarity scores, sending results of the linking step to the requesting application, and saving the results in a persistence database. The processing profile may be embedded inline in the autolink command. The target document attributes and associated schema may be embedded inline in the autolink command. The source document attributes and associated schema may embedded inline in the autolink command.

### BRIEF DESCRIPTION OF DRAWINGS

These and other features, aspects and advantages of the present invention will become better understood with regard to the following description, appended claims, and accompanying drawings wherein:

FIG. 1 shows a link analysis engine in relation to other cooperating applications;

FIG. 2 shows three levels of comparison provided by a link analysis engine;

FIG. 3 shows various software application architecture levels in a link analysis solution;

FIG. 4 shows a high-level architecture of a link analysis engine;

FIG. 5 shows a configuration file used by a link analysis engine server;

FIG. 6 shows an Autolink command for initiating a link analysis request;

FIG. 7 shows a Link Analysis Profile;

FIGS. 8A and 8B show Autolink Command Responses;

FIGS. 9A through 9D show Result Detail Options for Autolink Command Responses;

FIGS. 10A and 10B show a LinkAnalysys Command and result Detail per option 2;

FIGS. 11A through 11F show combinations of source and target data processing scenarios;

FIG. 12 shows an example of link analysis processing according to the present invention; and

FIG. 13 shows a process flow diagram of the description of FIG. 12.

### DETAILED DESCRIPTION

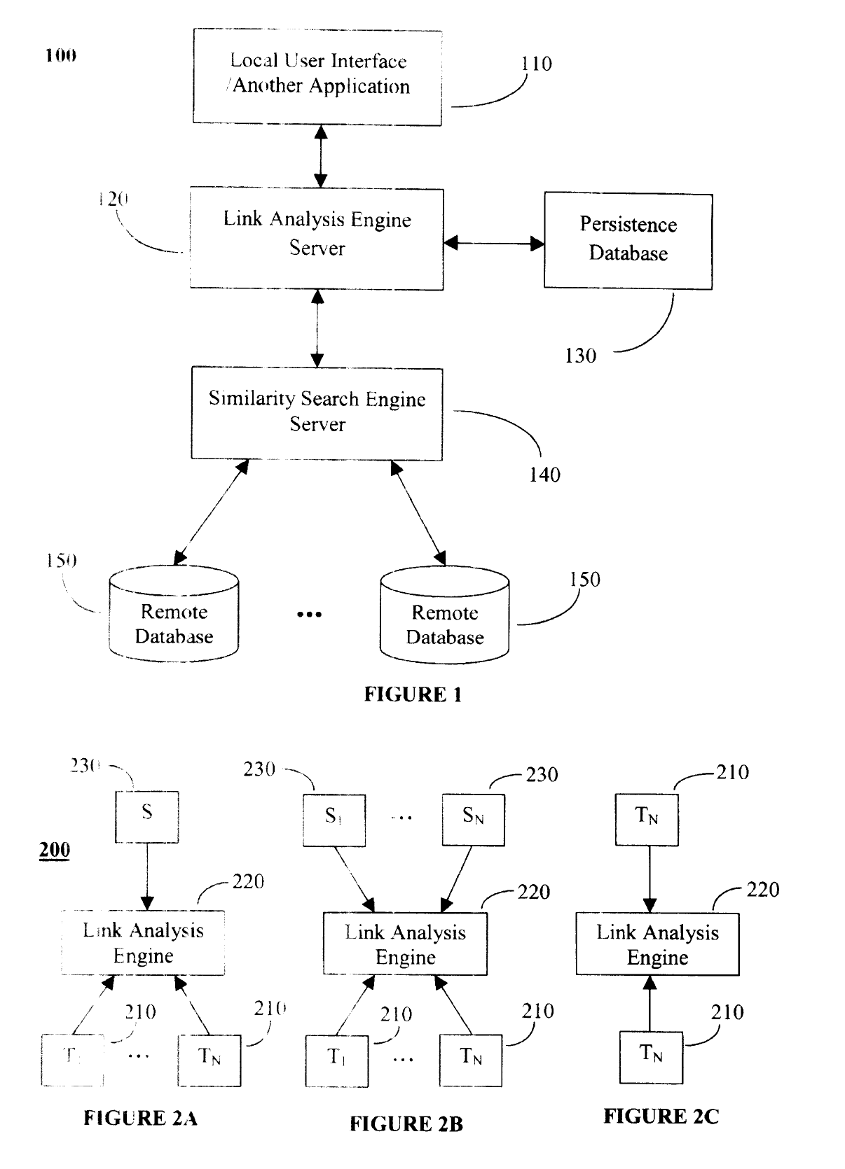

Turning now to FIG. 1, FIG. 1 shows a link analysis engine in relation to other cooperating applications 100. A local user interface or another application 110 may provide a command to initiate a link analysis by the link analysis engine server 120.

The link analysis engine 120 compares one or more input or “source” records against one or more “target” records designated in a processing profile. The records are normally contained in one or more remote, disparate databases 150 and are compared by a similarity search server 140 and associated remote similarity search agents. Comparisons are at a field level, and are normally performed by the remote similarity search agents using measurement and comparison functions of the similarity search server 140 with remote search agents, described and incorporated above. The resulting comparisons may provide a single score, a mathematically derived score, or a set of scores. High performance is one of the primary objectives of the link analysis engine. Results are provided in sub-second response times. Whether used as an analytic or as a command server, optimal performance is provided. Results from a link analysis are stored in a local persistence database 130 and returned to the calling user interface or application 110.

Link Analysis comprises the process of relationship determination amongst data. Given one or more input or source records, the input records are compared and scored against a set of target records. The fields to compare and the method of comparison is configurable and defined as part of the input to link analysis engine 120, provided as a processing profile. Processing profiles can be pre-built to define the operational behavior, including which fields are compared, how they are compared, how scoring is summarized, how results are handled, and others. The functional objective is to determine how many relationships exist for each source record and to capture the similarity scores that caused the system to identify each relationship. Various amount of detail can be provided to further describe the relationships. Or, in its simplest form, only the number of relationships may be obtained. The processing profile defines the level of detail that is to be provided.

Turning to FIG. 2, FIG. 2A through FIG. 2C show three levels of comparison 200 provided by a link analysis engine. FIG. 2A shows one source document 230 compared against many target documents 210 by a link analysis engine 220, referred to as an analysis type “single”. FIG. 2B shows multiple source documents 230 compared against many target documents 210 in different groups by a link analysis engine 220, referred to as an analysis type “multiple”. FIG. 2C shows a comparison of documents 210 within a group with each other by a link analysis engine 220, referred to as an analysis type “group”. The analysis process consists of taking each source document 230 to compare values in each target document 210 using the set of fields to compare from the processing profile. The result of each comparison is a raw similarity score. Typically, one source document is compared to one target document at a time, but techniques for simultaneously comparing multiple sources to multiple targets are used as well.

Various processing control directives are used to provide operational granularity. A “stop processing if a specified number of links exists” option allows the process to stop comparing whenever a certain number of links have been found for a source. A link is “found” when a similarity score falls within some specified threshold. Results of the analysis include a collection of various scores, one per each attribute comparison. The raw scores can be altered by weights to affect an overall score. Various scoring summary options are available. They apply to the aggregate score for a comparing the combination of each weighted individual value. These may include match counts, using threshold scores to indicate matches. This uses a combination of the similarity search score and a threshold value, such that if the score is within the specified threshold range, a relationship exists. Another option is average top scores for a key. This takes the matching scores for a source with the given document key, and averages them or provides various statistical operations on the collection of scores. The maximum and minimum score values are available with this average.

Output from a link analysis engine may consist of various levels of detail. The result of every field-to-field comparison is available as the lowest-level and most comprehensive detail. More practical may be just the cases where score thresholds were exceeded. Overall summary results are also available as described below. The amount of data that is provided as output, including what is stored in a database, is defined as part of the processing profile.

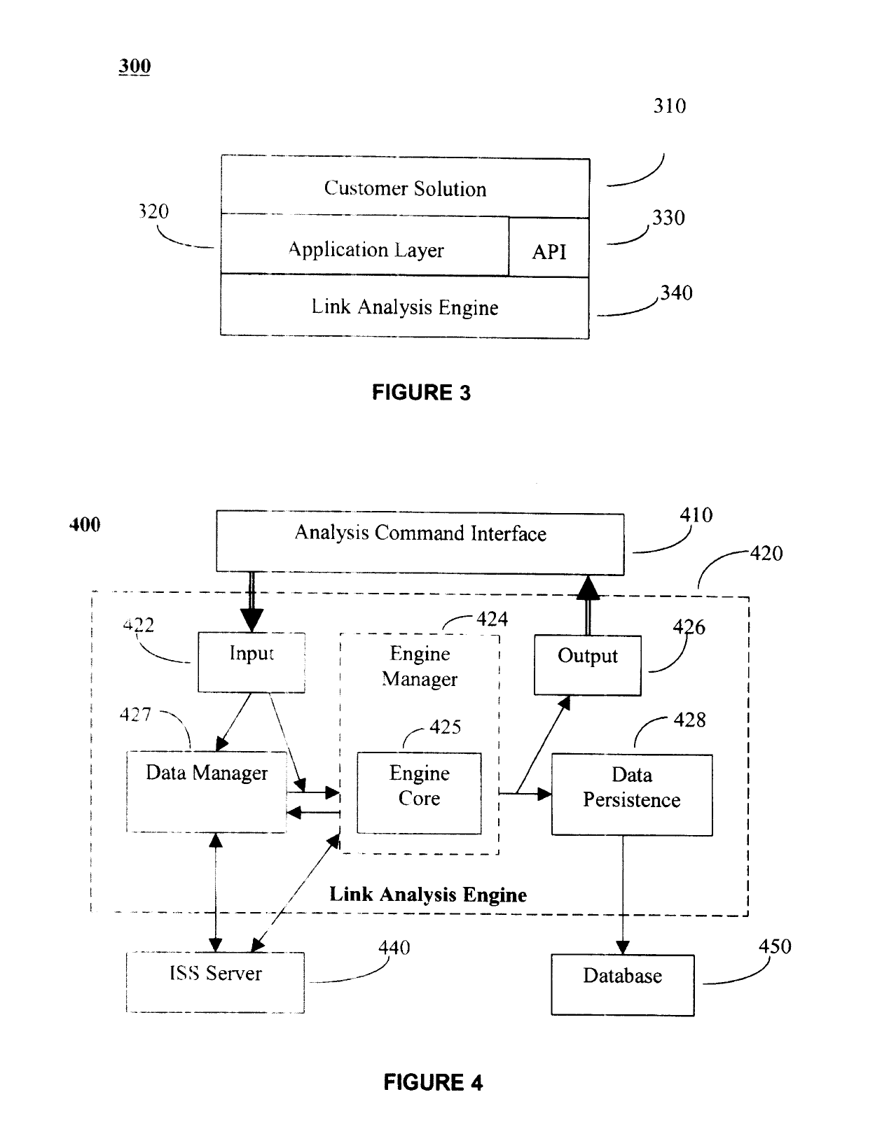

Turning to FIG. 3, FIG. 3 shows various software application architecture levels 300 in a link analysis solution. At the lowest level 340, the link analysis engine layer performs the actual analysis. The link analysis engine 340 is an application that handles analysis requests from either another application or through a XML command-oriented Application Programming Interface (API) 330. The application layer 320 is where much of the analysis configuration and preparation occurs. The application layer 320 is where data sources are identified, schemas are created and used, and data link analysis engine Processing Profiles are maintained. At the highest level is the customer solutionlayer 310. Custom user interfaces and applications, as well as user-level product applications, reside at this level. They use the application layer 320 and/or APIs 330 to perform link analysis activities.

Turning to FIG. 4, FIG. 4 shows a high-level architecture 400 of a link analysis engine. The link analysis engine functions as an XCF command server, where XML command input and XML response output define a command-driven interface. The analysis command interface 410 defines the communication protocol used to communicate between the link analysis engine 420 and other user interfaces or applications. The link analysis engine 420 consists of several sections, which can functionally be grouped into input processing 422, 427, analysis 424, and output processing 426. The input processing section 422, 427 supports the command input, which defines what to analyze, operational options and how to perform the analysis using a processing profile. In FIG. 4, the input 422 and the data manager 427 sections make up the input processing section. The input 422 contains designation of source data that is to be compared with target data. If the input source data documents are not provided, but only a key or keys are given, the data manager 427 obtains the input data documents from a similarity search engine server 440. Similarly, the target or “compare to” data should be provided where practical. The processing profile may define whether the target data should be obtained from a similarity search engine server 440 if the data is not present. The data manager 427 obtains the target data from the similarity search engine server 440 as needed.

In its simplest form, the input 422 may refer to a processing profile instead of providing the full processing parameters. In this case, the data manager 427 would obtain the processing profile and proceed to get any data that was needed per the profile definitions. The profile data may be cached so that it only needs to be built once. If target data is read from a database, the read may only need to be done once instead of each time. As part of the caching strategy, a time limit indication would be used to indicate that the data may be stale and needs to be reloaded the next time the profile is used. In addition, a command option could force a reload or indicate explicitly that cached values be used.

The analysis section consists of the engine manger 424 and the engine core 425 sections. The engine manger 424 interfaces with and manages the engine core 425. The engine manager 424 may submit a single request to the engine core 425 or send multiple, partial requests to the engine core 425, depending on the size of the analysis and target data availability. The engine manager 424 may get blocks of target data documents from the data manager 427 as needed, or it may send query commands to a similarity search engine server 440. The engine manager 424 is responsible for building the set of results from the engine core 425, and passing them on as output to the output section 426. The engine core 425 is the component that performs the actual analysis and link detection functionality. Input to the engine core 425 is the operational directives from the processing profile, detailed source data records, and where practical, all target data records. Target data comparisons may be deferred to the data manager 427 or a similarity search engine server 440 as external query commands when very large data sets are encountered. Any interaction with the data manager 427 is provided by the engine manager 424. The engine core 425 requests additional data from the engine manger 424 as needed. Output 426 of the engine core 425 are detailed results of the analysis. The amount of detail provided is defined by the processing profile.

The output processing, consisting of the output 426 and data persistence 428 sections, performs two functions. If results are to be stored in a database 450, data persistence 428 stores the requested results. Partial or complete storage is allowed per processing profile options. In addition, the command-level output response results are built and returned to the caller through the analysis command interface 410.

For optimal performance, all source and target data used within the engine core 425 reside in memory within the data manager 427 and is provided as documents to the engine manager 424. However, if very large sets of target records are to be processed, memory may not be available to hold all the target data. One solution is to perform the analysis in pieces, passing only part of the target data to the engine core 425 as needed. The engine manager 424 provides this transactional functionality. Multiple calls may be made to the engine core 425, and the results are combined into the single set of results. Another approach is to use the similarity search engine server 440 to obtain a set of complete or partial scores resulting from a query request. In this case, the target data would exist entirely within the searched databases and would not be read into the link analysis engine 420. Iterative calls or specialized queries may be used to get multiple results as needed when multiple input documents exists. For a single input document compared to a large target data set, this approach is typically the most efficient, since only one query to a database is needed to get the set of desired scores. In addition, to obtain optimal performance, when processing occurs in the engine core 425, the formats of the source and target data are identical. This allows the engine core 425 to operate on data that is structured the same, thereby removing the overhead of data mapping and translation operations. As such, any data manipulation, preparation, mapping, and translation would occur either outside the link analysis engine 420 or within the input processing sections 422, 427 of the link analysis engine 420.

The link analysis engine 420 operates as a command server. The server connects to a separate similarity search engine server 440 gateway, where query and document read operations are performed. The server contains a configuration file that defines the connectivity and settings for the server and is described later in this document.

The command interface 410 receives command inputs and returns command response outputs, and is represented by the input section 422 and output section 426. A XCF command handler will implement this functionality. A request to use the services of this engine is considered transactional, whereby the request is received, processed, and a response is returned to the requester.

The data manager 427 looks at the input data and determines if either source or target data is needed. If any data is needed, a similarity search engine server 440 is called to retrieve the data. A query or document read command may be issued to the similarity search engine server 440 to get the requested documents. Data obtained from this step is then combined with the input data and passed on to the engine manager 424. The engine manager 424 may call the data manager 427 to get blocks of data as needed. In addition, if a processing profile is identified but does not exist as part of the input data, the data manager 427 retrieves the processing profile.

The analysis engine manager 424 manages the operation of the engine core 425. It calls the engine core 425 and collects its results. In regards to the other components, the engine manager 424 provides the functional interface to the actual engine core 425, while accepting its inputs and providing its outputs.

The analysis engine core 425 performs the link analysis. It uses the given source and target data, analyzes it, and provides results. This component may assume that all needed data is available and is being passed into it. It operates with memory only and does no file I/O operations. Its primary input is a processing profile, containing all data and all operational properties. The engine core 425 compares two records at a time, obtaining an overall similarity score between the two records. The overall score is a normalized score, based on individual comparisons and weights. Note that this is performing what the similarity search engine server 440 is already doing: comparing two documents per some schema that tells it what fields, measures and weights to use.

Results from the analysis engine core 425 may be persisted to a database 450 or file system. This component performs such persistence operations. Note that the persistence may optionally be performed in a separate thread from the transactional command. By letting the command complete and return to the caller, the transactional command can complete sooner, while the results are still being stored. This is a configurable option, in that the command may need to save its results before completing.

The mapping of input to output and the methods of comparison can all be predefined in a processing profile. All the processing parameters can therefore be provided and pre-set in this profile. Otherwise, all aspects of the analysis are passed in as part of the command to the link analysis engine 420. The processing profiles exist as XCF components to the link analysis engine server 420. The contents and structure of processing profiles are described later in this document.

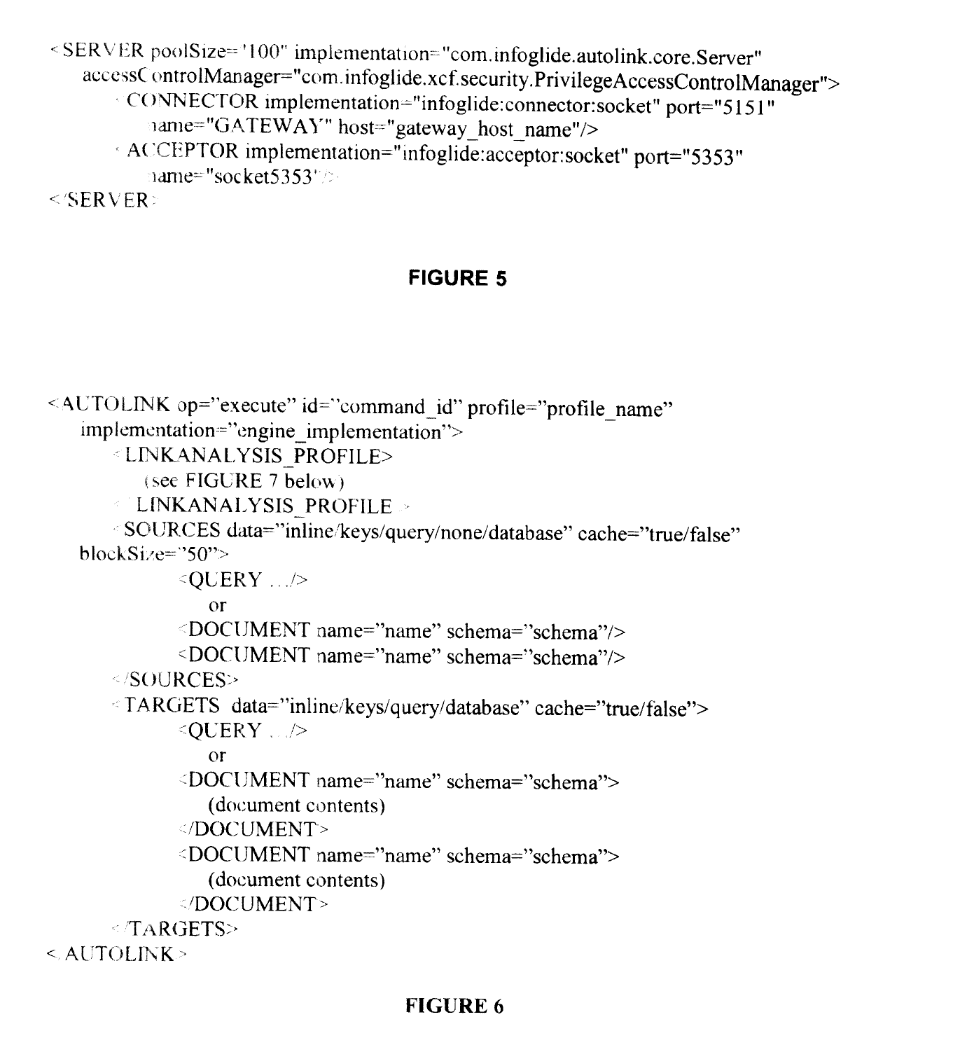

Turning to FIG. 5, FIG. 5 shows a configuration file used by a link analysis engine server. The SERVER element contains several attributes. The poolSize is the standard command handler pool size for the maximum number of concurrent commands that can be executed on the server. The default is 100. The attribute implementation defines the java class that operates as the server. This value must be defined exactly as shown. The attribute accessControlManager defines the security implementation, limiting access to the server to authorized users. The CONNECTOR element defines the connection to the Similarity Search Engine Gateway that is used for query and document read operations. The host attribute must define the IP address or host name of the machine running the Similarity Search Engine Gateway application, where “localhost” is used for running on the same machine. The ACCEPTOR defines the port that this server listens on. Other applications can communicate to this server by connecting to this port. Port 53 is the typical system port used by this server.

Security to the link analysis engine server is supported through the default XCF security layer. Access to the server itself is restricted to recognizable users with valid passwords. Any user who can access this server can execute the AUTOLINK command. The users are managed with standard administration applications. If profile persistence and access are provided by this server, appropriate user-level privileges is supported to restrict access to profile editing and viewing.

Turning to FIG. 6, FIG. 6 shows an Autolink command for initiating a link analysis request. The attribute op defines the command as a command process execution command. The attribute id is the standard command-level ID, provided by the caller. The attribute profile is the name of the processing profile to use. This is optional if the LINKANALYSIS_PROFILE element is provided. The attribute implementation defines the engine processing class to use to support the command. If not provided, if an implementation is defined in the processing profile, that implementation is used. If the implementation is not specified anywhere, then a default will be selected based on the various command settings. The SOURCES element contains the source documents. The document contents can be provided in full as part of the command, or only the skeletal part can be provided, in which case the contents will be filled in before processing. Alternatively, a QUERY statement can be used to run dynamically to get the document contents from a similarity search server. The data attribute defines how the source

inline—the source documents are provided fully in the command

keys—one or more document keys are provided; the source documents are to be queried to get their full contents (document name is document key)

query—a QUERY command is provided, which is to be used to query the source documents

none—no source documents are used; the targets are to be compared against each other

database—the documents are to remain in the database and queried one by one as needed

The SOURCES element also contains other attributes. The cache attribute indicates to the Link Analysis Engine whether the data should be cached or not. A true value causes the data to be cached, while false does not cache. The attribute blockSize defines the maximum number of sources that can be processed at one time, usually as input to a coalesced query. This value applies to all source types except for none and when the profile analysisType is not single. The default for this value is 0, meaning no limit.

Similar to SOURCES, the TARGETS element contains the set of data to compare with the sources. This can contain a list of documents containing the full document values, or this can contain a QUERY to execute on a similarity search engine server to get the document elements. The data

inline—the target documents are provided fully in the command

keys—one or more document keys are provided; the target documents are to be queried to get their full contents (document name is document key)

query—a QUERY command is provided, which is to be used to query the documents

database—the documents are to remain in the database and queries are executed against them there. This option would be applicable when very large datasets are used and the database is to perform the similarity searching.

The cache attribute indicates to the Link Analysis Engine whether the data should be cached or not. A true value causes the data to be cached, while false does not cache.

With the above command structure, both the SOURCES and TARGETS contents can be provided by the Link Analysis Engine. Command “data” attribute settings define how the sources and targets are to be obtained or used. Either all source records are provided within the command, all are to be read in from their source database, or each source document is to be read in as needed and processed. For targets, either the requested target documents are read in, or the similarity scoring operations are performed within the control of the ISS Server, in which case the database itself is used to perform the individual similarity scoring on all the documents. The former is useful for getting a smaller set of data and perhaps caching it for multiple requests. The latter is useful when working with very large target data sets, where reading in all the documents in not practical. The engine is capable of operating in either mode, thereby supporting various levels of performance and data caching options.

In each of the DOCUMENT elements, the entire document contents can be provided. The schema attribute is used to identify the source of the data. This schema name is reflected in the output so that the location of the targets and sources is known, since the schema defines the database the data resides.

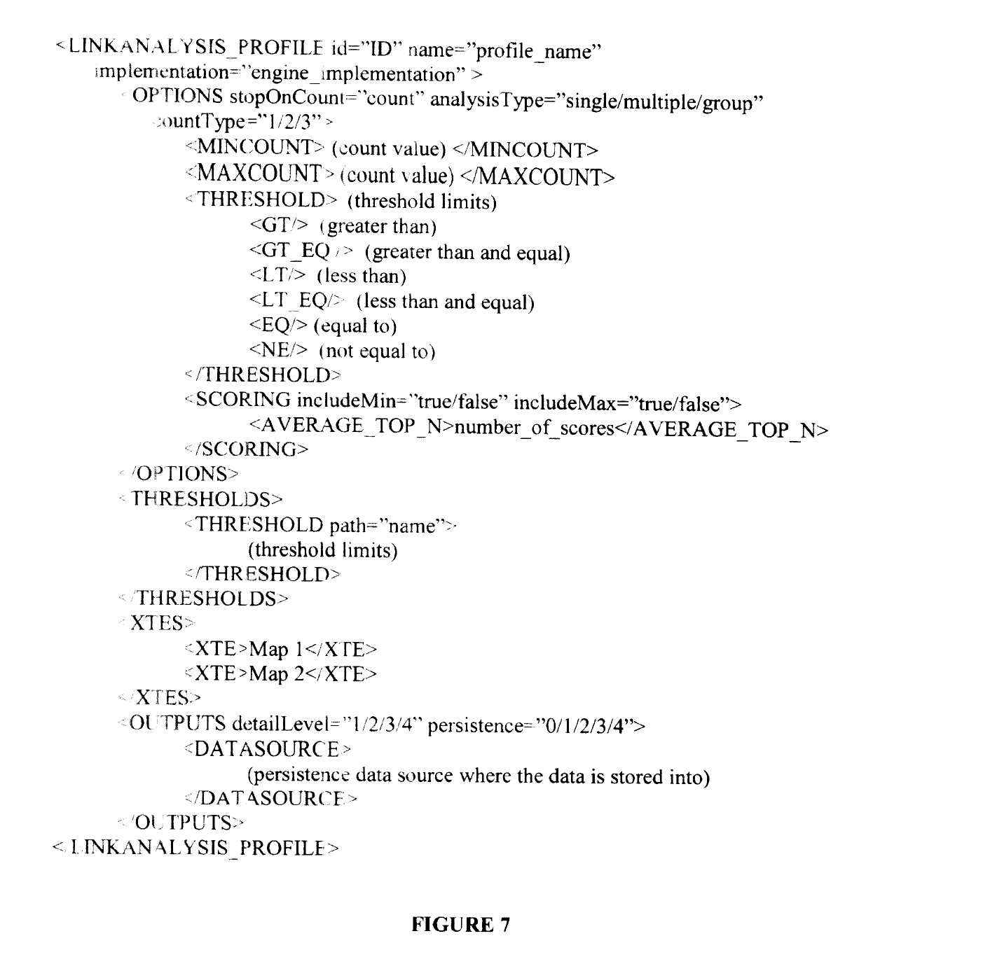

Turning to FIG. 7, FIG. 7 shows a Link Analysis Processing Profile. The Processing Profile defines how the link analysis engine gets its data, what operations it performs, and what results it provides. The Processing Profile is defined with an XML structure. Note that this can exist independently as a component in an XCF server as a configurable server component.

The attribute id defines a unique numeric identifier for these profiles. The attribute name defines the name of the profile. The attribute implementation defines the engine processing class to use to support the command. If provided here and in the AUTOLINK command, the implementation in the AUTOLINK command takes precedence. If not provided in either place, a default will be selected based on the various command settings.

The OPTIONS element defines the processing directives. The attribute stopOnCount defines the number of counts, that when this many links are found, no other searches are needed. The attribute analysisType is the type of analysis; this defines how the sources and targets are to be analyzed and used. A value of single means that a single source record is compared against a set of target records; this is very similar to a normal similarity search of one document against a target database, except that link counts are provided instead of similarity scores. A value of multiple means that multiple source resources are compared to a set of target records. In both single and multiple, separate sources and targets are defined. Type group, in contrast, compares all documents within a target set with each other; the sources are the targets themselves. The OPTIONS element also contains the countType attribute. This defines how a “link” is identified or what scoring actions are to take place. A value of 1 indicates to use a “match counts” approach, where comparison similarity scores within the specified threshold value(s) indicates an increment to the link count. A value of 2 indicates to use the scoring options instead of match counts; this would be used to obtain a statistically produced score of some set of documents. For example, get the average of the top scores for a set of documents. A value of 3 indicates to use a combination of 1 and 2, where a score value obtained from scoring, such as an average of top scores, is compared to the threshold, and a link exists if the averaged score is within the threshold. This latter option allows a scoring function to be performed against a set of score results, and the result of that scoring function is then used to indicate if a match exists. The MINCOUNT is an optional minimum number of links that must be found; link counts values below this number are ignored. A value greater than 0 must be specified. The MAXCOUNT is an optional maximum number of links that must be found; link counts values above this number are ignored. A value greater than 0 must be specified if this is used. The THRESHOLD element defines a range or minimum or maximum value of the overall similarity score that indicates a linked relationship. Multiple value range elements may be provided here to define a range of values. The values must be between 0 and 1.0. All value elements are logically “anded” together to determine if the score is within the specified threshold restrictions. The THRESHOLDS element contains element-level specific thresholds that may be used to indicate a match. By default, the match determination is performed at the entire document level, using the combination of normalized weighted similarity scores. By providing threshold values here, a finer level of control can be specified at each data attribute element. The format of a THRESHOLD is as described above. The SCORING element defines score aggregation options, where individual similarity scores (from document-level compares) are combined into one or more calculated values. Attribute includeMin, when true, causes the minimum score value used in calculations to be provided in the output. Attribute includeMax, when true, causes the maximum score value used in calculations to be provided in the output. Various elements define the type of scoring actions that take place. Element AVERAGE_TOP_N averages the top “n” scores for a key.

The XTES element contains a list of XTE maps that may be used by the analysis schema. Note that this element may not be needed if the schema is aware of the XTE maps it needs. The OUTPUTS element defines the type of output that is desired. Attribute detailLevel defines the amount of detail provided in the results, where 1 is the least of amount of details, and 4 is the most comprehensive (see Result Detail Optionsbelow for the values and what output is available). Attribute persistence defines whether the results are to be stored in a database or other persistence (such as a file). A value of 0 indicates to not store any results. Any other value corresponds to the amount of detail as defined in detailLevel; results at or below the detailLevel can be stored. If persistence has a higher value than detailLevel, the value of detailLevel is used instead. Detailed results cannot be persisted if they do not exist. If the results are to be stored, the DATASOURCE element defines the XML of a persistence driver or data source that can store the data.

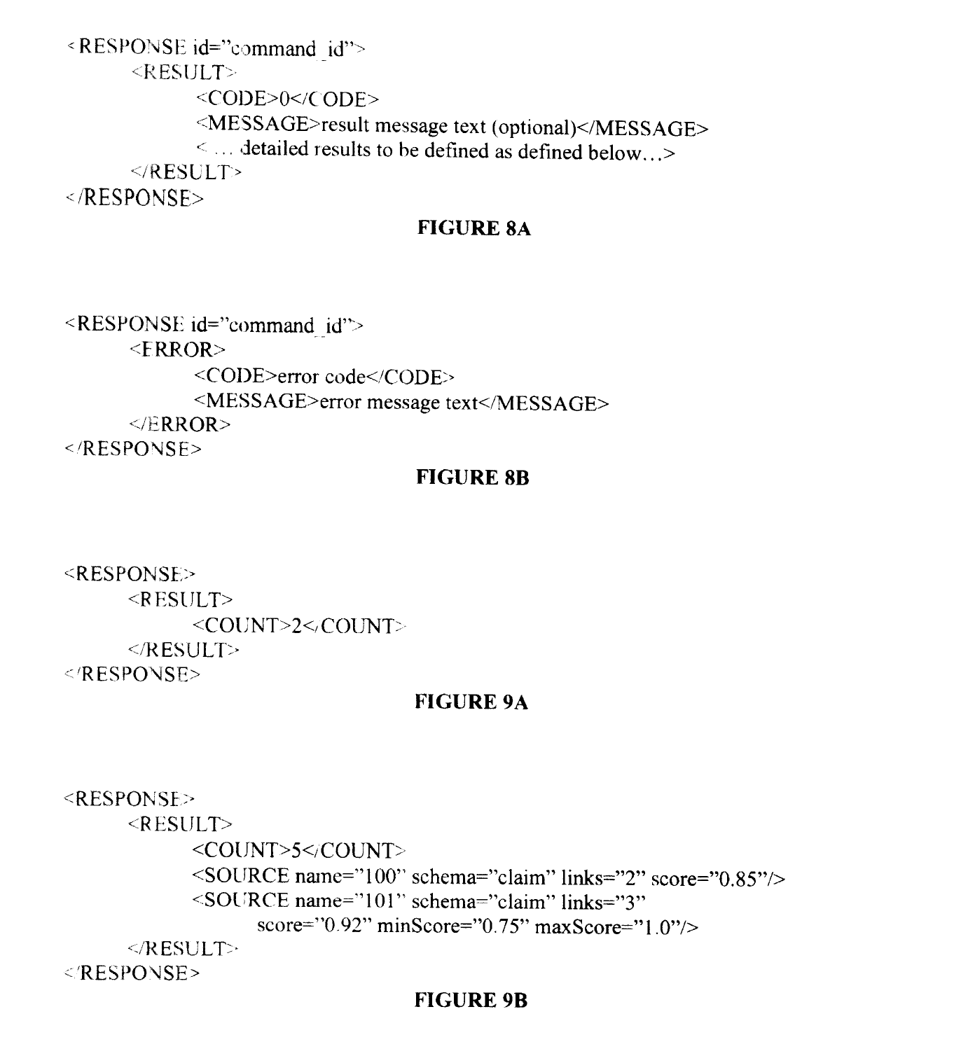

Turning to FIG. 8, FIGS. 8A and 8B show expected Autolink command responses. FIG. 8A depicts a valid result from an Autolink command. FIG. 8B depicts an error result from an Autolink command. Attribute id is the command-provided identifier of the request, if any, echoed in the output response. Normal responses contain the RESULT element, with an optional MESSAGE element. Varying amount of details can be included as described below.

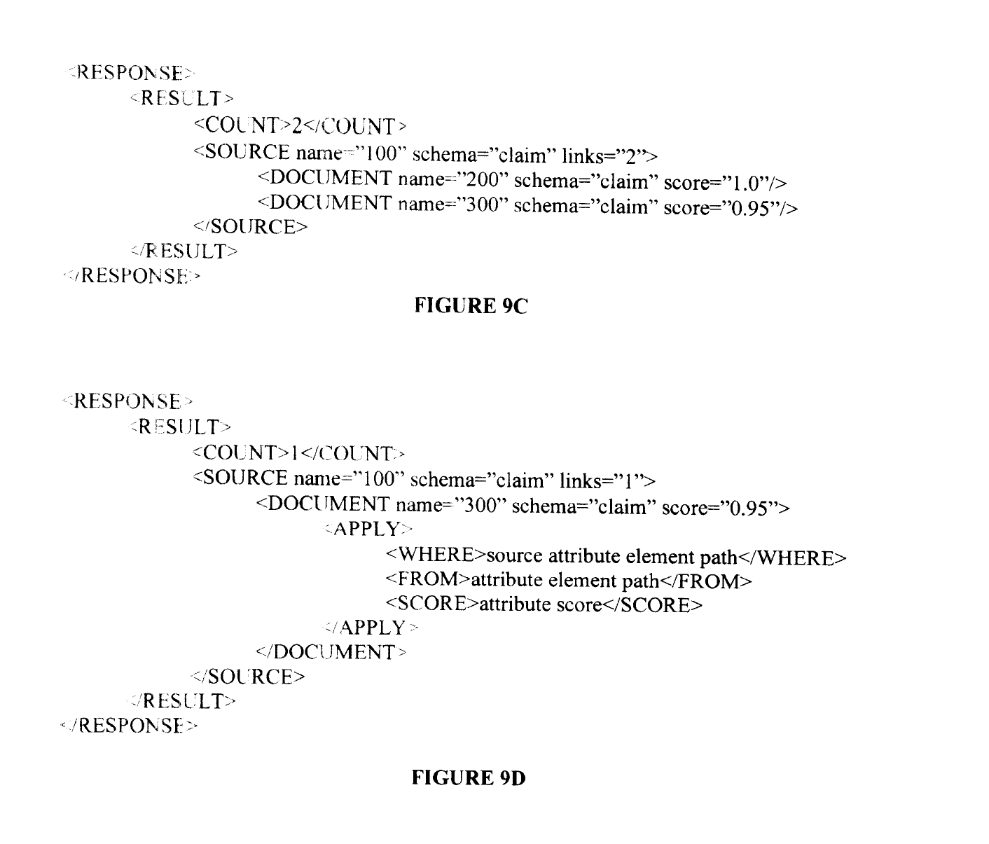

Turning to FIG. 9, FIGS. 9A through 9D show Result Detail options for Autolink command responses. The following describe the output detail options, from least detail to most detail. The OUTPUT detailLevel from the Processing Profile defines which Output Option is desired. The default option is 1. FIG. 9A depicts output option 1, which is the simplest level of response detail and includes only an overall result indicating the count of any links or matches that were detected. The single element, COUNT, contains this result. This value is valid only for link count requests; for score-related requests, the returned value is always 0.

FIG. 9B depicts output option 2. This level of response detail includes the source documents, with a links count, a score, or both, depending on the countType processing option. As in output option 1 shown in FIG. 9A, the COUNTelement contains the total number of links or matches that were detected. This is the sum of all individual links values. This value is 0 for non-link count requests. The RESULT element contains all of the returned Source documents. Each source document is described in a SOURCE element, with name being the document key and schema being the schema used to describe the document. The rest of the attributes depend on the processing type from countType. Note that if a group is being compared to itself in the analysis, where all documents are in the “target” data set, the result will still list each relevant document as a SOURCE; in this case, all documents are both sources and targets, so the SOURCE concept still applies. For a countType that gets a link count, the links attribute returns the number of links found. Source documents with link counts that fall within the required values (MINCOUNT and MAXCOUNT in the Processing Profile) are included in the results, while others are excluded. By default, if no MINCOUNT is provided, any source with a link count greater than zero will be included in the results. For a countType that gets an overall score, the score attribute returns the calculated score. Other scoring values are included if requested, including minScore and maxScore. Attribute minScore returns the minimum score used in the calculations, not necessarily the minimum overall similarity score of all documents. For example, if the top 2 scores are averaged together and there are four scores of 1.0, 0.9, 0.8, and 0.7, the minScore would be 0.9, since of the top 2 scores, it is the minimum value used. Attribute maxScore returns the maximum score used in the calculations. For a countType that gets the count of an overall score within a threshold (thus a count of “1”), both links and score are returned, along with any other scoring options.

FIG. 9C depicts output option 3. In this option, in addition to the details provided in output option 2, the individual documents that match or were used in the score are included in the results. Each document is identified by its name and the schema that represents it. It also contains the similarity score from the comparison. Documents that did not meet the link count criteria or were not used in scoring calculations are not included in this list. Note that while only one SOURCE is shown, multiple SOURCE elements may exist in the results.

FIG. 9D depicts output option 4. In this option, in addition to the details from output option 3, the result of each attribute-level similarity score is provided. An APPLY element defines the result of each evaluated element. The structure and contents are identical to a detailed score result from a QUERY command. The FROM defines the name of the target document element or field, and the SCORE contains the resulting raw, non-normalized similarity score. The WHERE element defines the source document element or field.

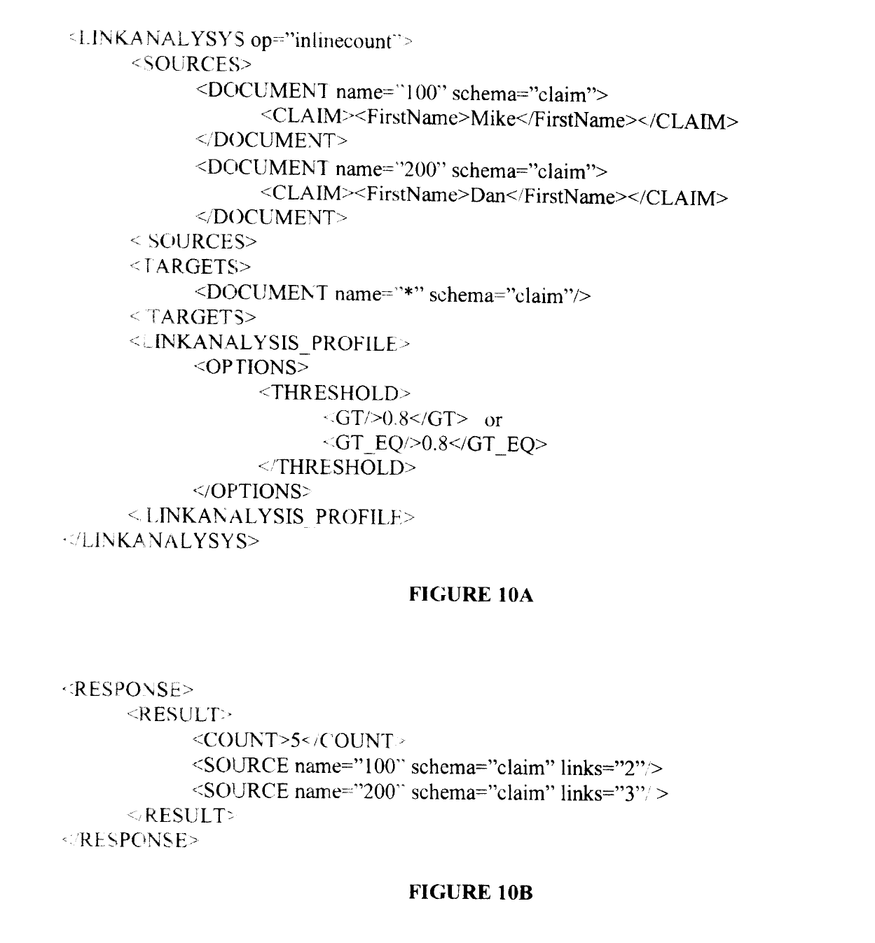

Turning to FIG. 10, FIGS. 10A and 10B show a LinkAnalysys command and Result Detail per option 2. Various commands will be issued to the internal analysis engine. These commands are constructed from the main AUTOLINK command, into LINKANALYSIS commands that contain data items for specific sub-commands. The commands are internally passed to the similarity search engine gateway server for handling. The LinkAnalysys command takes one or more source documents and obtains a count of the number of links of each source document. The targets exist in a database, and all operations are performed within the database itself. The response is limited to detail levels 1 and 2.

Considering the architecture shown in FIG. 4, the architecture of the automated link analysis engine supports a variety of processing options. A few options primarily define the overall processing strategy. The main factor is the location of the source and target data, with the level of result details and the type of analysis requested being secondary factors. The location of the data determines what steps are needed to access the data and how the data is used in searches. The result details and analysis type affects how the data can be searched, since faster searches can be performed when less results are needed. While a single software solution can provide a generic, brute-force processing approach to all the various combinations of source and target data and other options, such a solution would not provide the best performance in many of the option scenarios. Therefore, various engine implementations are provided, each designed to process a set of options in a manner that is most efficient for those options. Each implementation is an implementation of an engine manager, which provides a common interface to raw engine functionality. An engine manager invokes explicit engine core functionality and manages the data and results around the call. Multiple simultaneous calls may be made to one or more engine core functions, depending on the engine manager.

The basic, simple processing manager provides the common, simple engine processing support, tuned for single analysis or low-count multiple analysis types, where there are a limited number of inline source documents. The basic asynchronous manager makes numerous, simultaneous calls to perform individual analysis actions, suited for all other scenarios not supported by the basic manager. This manager typically issues multiple, internal analysis commands in an asynchronous fashion, waiting until they all complete before presenting the overall results. This is best suited for multiple sources or the group analysis type. Also, this must be used instead of the basic manager whenever the source documents reside in a database. The basic asynchronous manager reads documents from a database as needed. The inline count manager is optimized to provide a very fast, simple count of links result. It is limited to detail level 1 and 2, such that minimal result details are available. The targets must also reside on a database, since this is tuned to perform simultaneous database operations in a combined manner.

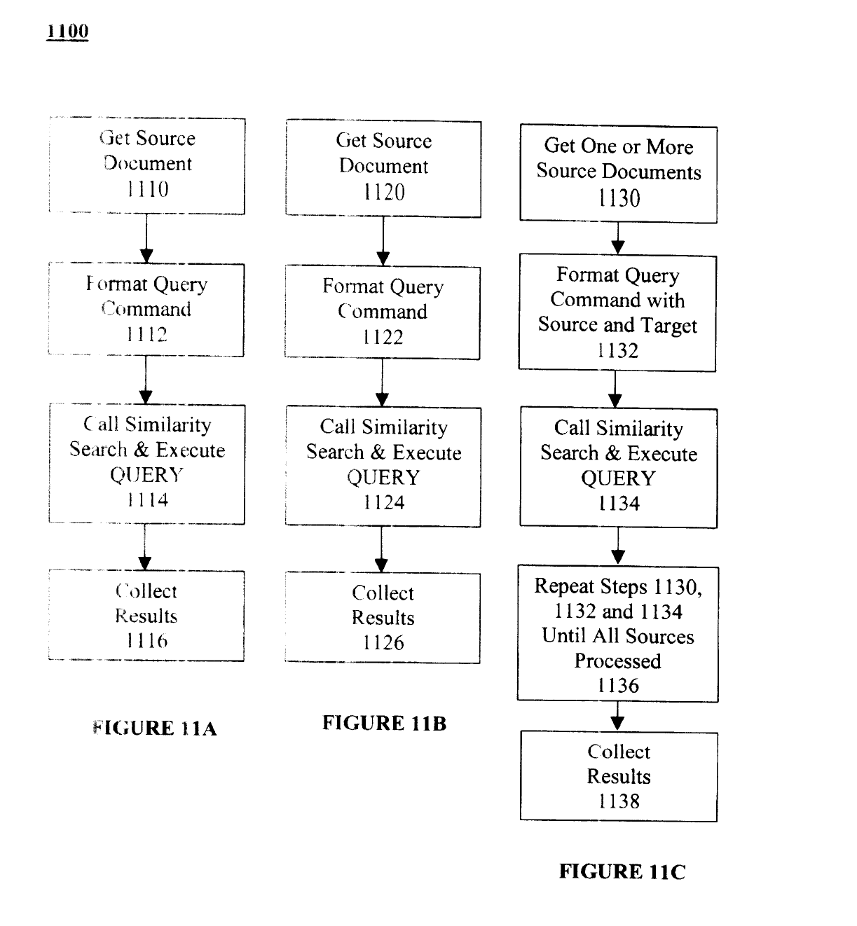

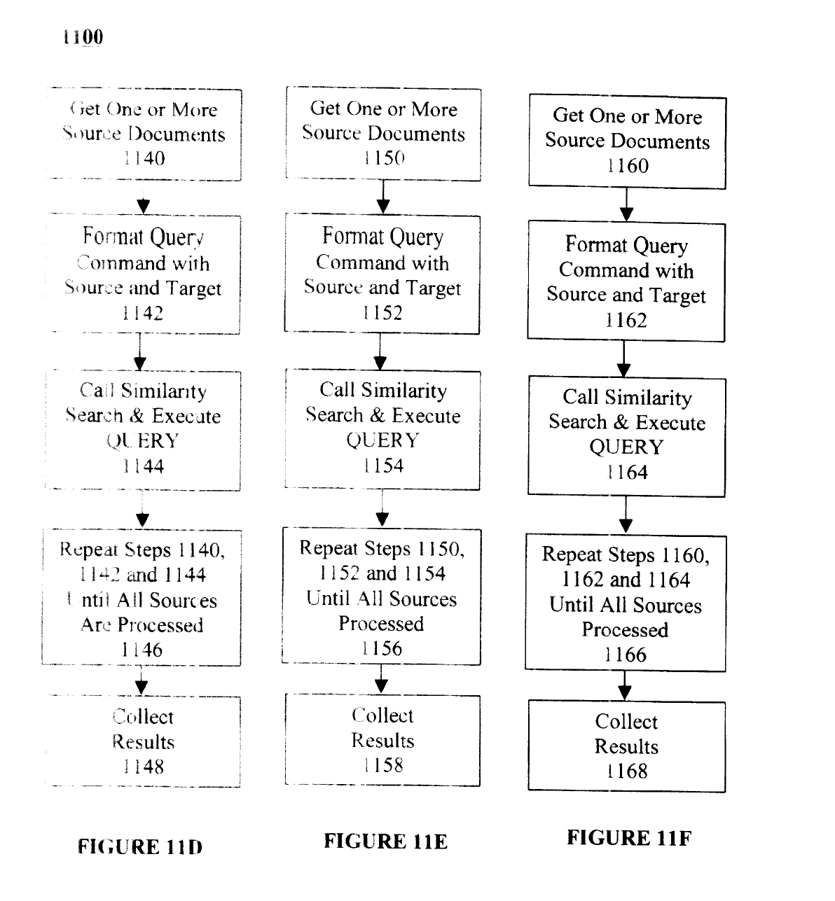

Turning to FIG. 11, FIGS. 11A through 11F show combinations of source and target data processing scenarios that are supported by the present invention. These are variations of source and target data locations and source vs. target and target vs. target comparison combinations. FIG. 11A depicts a one source record, in-memory target documents scenario. It comprises the steps of getting the source document 1110; formatting the Query command, using the source and target objects 1112; calling a similarity search engine server with a QUERY execute 1114; and collecting results 1116. FIG. 11B depicts a one source record, target documents on database scenario. It comprises the steps of getting the source document 1120; formatting the Query command, using the source data 1122; calling a similarity search engine server with a QUERY execute 1124; and collecting results 1126. FIG. 11C depicts a multiple source records, in-memory target documents scenario. It comprises the steps of getting one or more source documents 1130; formatting the Query command, using the source and target objects 1132; calling a similarity search engine server with a QUERY execute 1134; repeating the above steps until all sources have been processed 1136; and collecting results 1138. FIG. 11D depicts a multiple source records, target documents on database scenario. It comprises the steps of getting one or more source documents 1140; formatting the Query command, using the source and target objects 1142; calling a similarity search engine server with a QUERY execute 1144; repeating the above steps until all sources have been processed 1146; and collecting results 1148. FIG. 11E depicts a group of records against each other in memory scenario. It compares a set of target documents to each other, where all documents must exist in the target data. It comprises the steps of getting one or more records which become source documents 1150; formatting the Query command, using the sources and all or some of the targets 1152; calling a similarity search engine server with a QUERY execute 1154; repeating the above steps until all records have been processed 1156; and collecting results 1158. FIG. 11F depicts a group of records against each other on database scenario. The process involves performing a similarity search engine query, using each source's attributes as part of the query, but getting the source's data from the database to begin with. Then compare it to the rest of the documents, excluding itself. It is possible to combine a limited number of queries into a single query and execute them all at once, then get all the results back at once. When doing so, it is necessary to parse out the results and associate each result with a source key. It comprises the steps of getting one or more records from the database, which become source documents 1160; formatting the Query command, using the sources and all targets on the database 1162; calling a similarity search engine server with a QUERY execute 1164; repeating the above steps until all records have been processed 1166; and collecting results 1168.

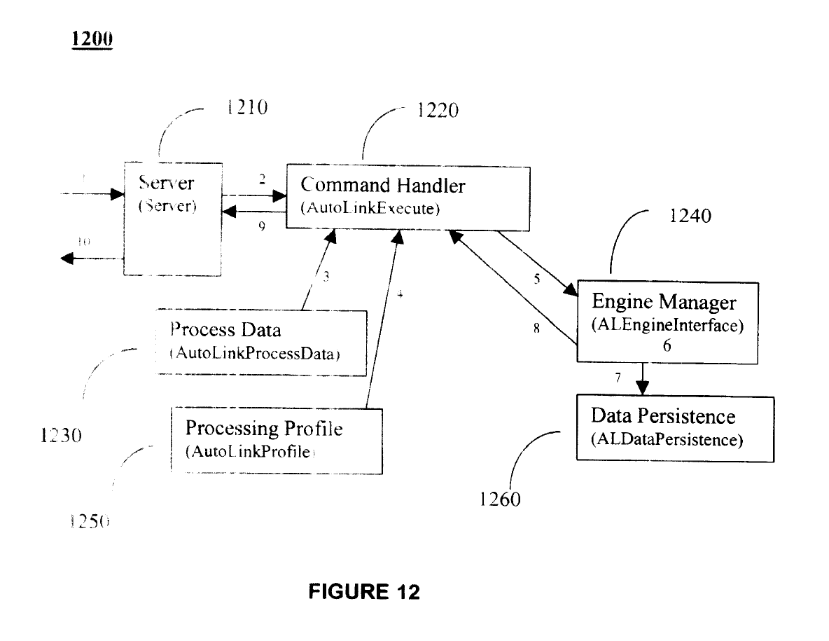

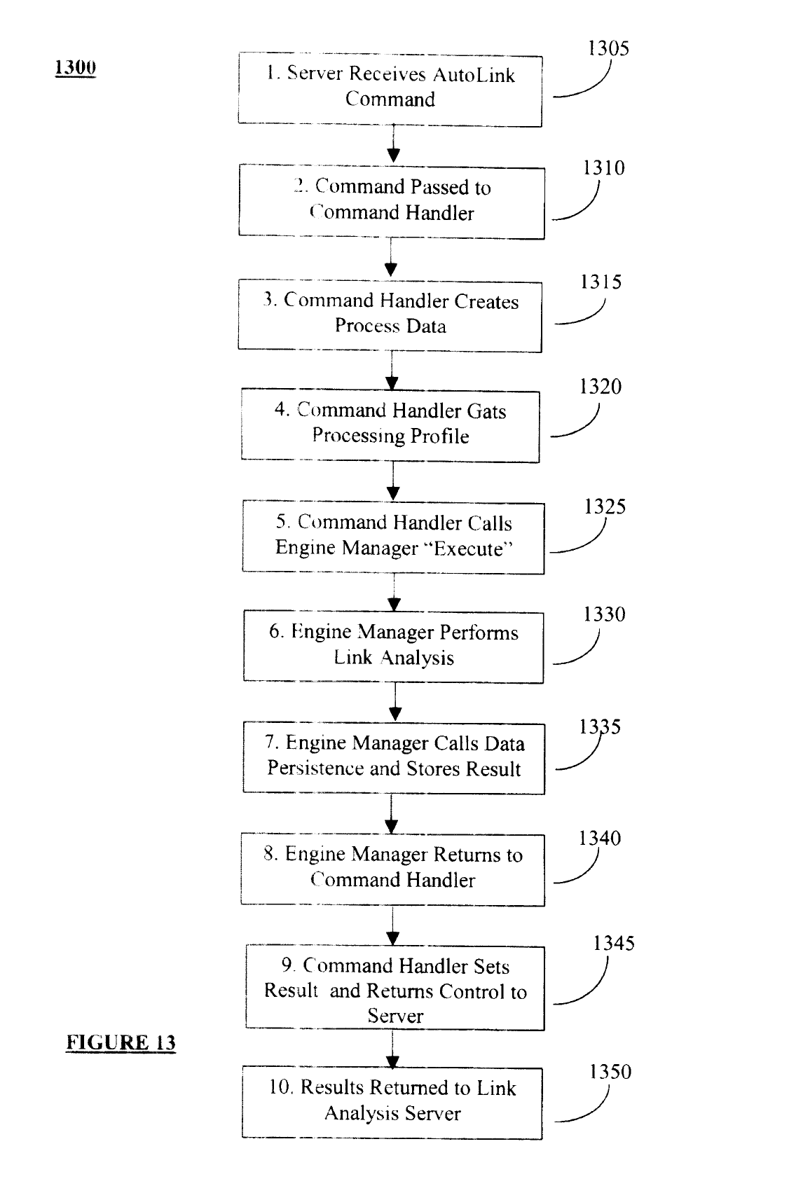

Turning to FIG. 12, FIG. 12 shows an example of link analysis processing according to the present invention. FIG. 13 depicts the corresponding process flow. One of the purposes of the automated link analysis engine is to handle AUTOLINK commands for performing link analysis processing. The following illustrates the high-level class design and operational steps taken to process an AUTOLINK command. The class names for each block are defined in parenthesis. The following processing steps are performed:

1. 1305 An AutoLink command is received by the Link Analysis Engine Server 1210;

2. 1310 The server 1210 passes command to Command Handler 1220;

3. 1315 The Command Handler 1220 creates Process Data 1230 from the command, extracting data and options;

4. 1320 The Command Handler 1220 gets the Processing Profile 1250 but if it was not passed in as part of the command, gets the profile from the Server's Component Manager;

5. 1325 The Command Handler 1220 gets Engine Manager 1240 and calls Engine Manager “execute” method;

6. 1330 The Engine Manager 1240 performs the link analysis;

7. 1335 The Engine Manager 1240 calls Data Persistence 1260 which stores results in a database per processing options;

8. 1340 The Engine Manager 1240 returns to Command Handler 1220;

9. 1345 The Command Handler 1220 sets results in command response; control is returned to the Link Analysis Engine Server 1210; and

10. 1350 Results are returned from Link Analysis Engine Server 1210.

The Command Handler 1220 is the primary processing controller. Its

1. Extract the process request data from the command;

2. Get the processing profile 1250 and engine manager 1240 as needed;

3. Call the engine manager 1240 to perform the link analysis; and

4. Pass results back to the server connection 1210.

The process data 1230 defines the various operational aspects and data for an AUTOLINK command. The Command Handler 1220 extracts the data from the command request and sets values in a process data instance 1230 (AutoLinkProcessData class). This class provides a convenient container for all the process-related parameters and inline data. It also contains the processing profile instance 1250 (AutoLinkProfile class) and the top-level result object instance (ALResultHeader class).

If the processing profile 1250 was not provided in the command as imbedded XML, then the profile 1250 needs to be obtained from somewhere; processing cannot continue without a processing profile 1250. If profile component have been persisted, the server's component manager will contain any AutoLinkProfile instances 1250. This component approach follows the XCF architecture for server-based components. The engine manager 1240 controls the detailed, low-level processing of the link analysis. Different managers provide different approaches to link analysis, each with its own benefits.

Finally, the result is what the AUTOLINK command requester wants, so the results are extracted from the result object instance and returned via the command handler's response handling methods, providing an XML response message back to the requester. If any error occurred during any part of the processing, error details are returned instead of link results.

Several classes exist for handling document data. Document data consists of sources and targets that are used during the link analysis process. Contained in the AUTOLINK command is a specification of the location of the link sources and targets. Whenever the sources or targets are inline, their entire definition is provided as part of the command. Therefore, an object for containing each source or target is provided. In addition, when source or target data is read from a database, an internal storage mechanism is provided for each one read. Several classes exist to support this data.

Although the present invention has been described in detail with reference to certain preferred embodiments, it should be apparent that modifications and adaptations to those embodiments might occur to persons skilled in the art without departing from the spirit and scope of the present invention.

1. A software method in a computer system for automatically analyzing relationships between target and source documents, comprising the steps of:
receiving an autolink command by a link analysis server from an application program;
accessing a processing profile identified in the autolink command;
accessing source and target document data identified in the autolink command;
performing a link analysis for identifying relationships based on comparing similarity scores between target and source documents; and
sending a response containing a link analysis result to the application program.

2. The method of claim 1, wherein the step of receiving comprises receiving an autolink command by a link analysis server from a user interface program connected to the link analysis server.

3. The method of claim 1, wherein the step of accessing a processing profile further comprises:
identifying an options element;
identifying a threshold limit element defining a path to threshold limit values;
identifying a mapping element for defining mappings between source and target document data;
identifying an output element for defining output attributes including detail level 1, detail level 2, detail level 3, detail level 4, persistence level 1, persistence level 2, persistence level 3, and persistence level 4; and
identifying a datasource element for defining a persistence data source.

4. The method of claim 3, wherein the step of identifying an options element further comprises:
specifying a stop-on-count attribute;
specifying an analysis-type attribute, including single, multiple and group values;
specifying a count-type attribute, including match-count, statistical and threshold;
specifying a minimum and maximum number of document links to be found;
specifying threshold limits for defining ranges of similarity scores for indicating linked relationships, including attributes greater-than, greater-than-and-equal-to, less-than, less-than-and-equal-to, equal-to, and not-equal-to; and
specifying scoring aggregation options, including attributes include-minimum, include-maximum, and average-top-N-scores.

5. The method of claim 1, wherein the step of accessing a processing profile comprises accessing a processing profile embedded inline in the autolink command.

6. The method of claim 1, wherein the step of accessing a processing profile comprises accessing a processing profile from a persistence database.

7. The method of claim 1, wherein the source document data comprises an inline designation attribute, one or more source document key attributes, a no-source attribute for indicating target documents are compared to each other, a query attribute, a database attribute, a cache designation attribute, and a block size attribute.

8. The method of claim 1, wherein the step of accessing source document data comprises accessing source document data embedded inline in the autolink command.

9. The method of claim 1, wherein the step of accessing source document data comprises accessing source document data from a similarity search server by issuing a query command to the similarity search server from the link analysis server.

10. The method of claim 1, wherein the target document data comprises an inline designation attribute, one or more source document key attributes, a query attribute, a database attribute, a cache designation attribute, and a block size attribute.

11. The method of claim 1, wherein the step of accessing target document data comprises accessing target document data embedded inline in the autolink command.

12. The method of claim 1, wherein the step of accessing target document data comprises accessing target document data from a similarity search server by issuing a query command to the similarity search server from the link analysis server.

13. The method of claim 1, wherein the step of performing a link analysis for identifying relationships is based on a comparison selected from the group consisting of:
comparing one source document with many target documents;
comparing multiple source documents with multiple target documents in different groups; and
comparing multiple documents within a group with each other.

14. The method of claim 1, wherein the step of sending a response is selected from the group consisting of:
sending a response containing an error message;
sending a response containing a count of link matches;
sending a response containing a count of link matches and source documents;
sending a response containing a count of link matches, source documents and document scores that were used in a link match result; and
sending a response containing a count of link matches, source documents, document scores and document attribute scores that were used in a link match result.

15. The method of claim 1, further comprising the step of storing the response containing the link analysis result in a persistence database.

16. A computer-readable medium containing instructions for controlling a computer system according to the software method of claim 1.

17. A software system for automatically analyzing relationships between target and source documents, comprising:
means for receiving an autolink command by a link analysis server from an application program;
means for accessing a processing profile identified in the autolink command;
means for accessing source and target document data identified in the autolink command;
means for performing a link analysis for identifying relationships based on similarity scores between target and source documents; and
means for sending a response containing a link analysis result to the application program.

18. The system of claim 17, wherein the application program is a user interface connected to the link analysis server.

19. The system of claim 17, wherein the autolink command comprises an embedded inline processing profile, embedded inline source document data and embedded inline target document data.

20. The system of claim 19, wherein the processing profile is accessed from a persistence database.

21. The system of claim 19, wherein the source document data is accessed from a similarity search server.

22. The system of claim 19, wherein the target data is accessed from a similarity search server.

23. The system of claim 17, wherein the processing profile comprises an options element, a threshold element, a mapping element and an output element for designating a persistence database.

24. The system of claim 17, wherein the means for receiving an autolink command comprises an input processing section of the link analysis server.

25. The system of claim 17, wherein the means for accessing the processing profile, the source document data and the target document data comprises a data manager section of the link analysis server.

26. The system of claim 17, wherein the means for performing a link analysis comprises an engine manager section containing an engine core within the link analysis section.

27. The system of claim 17, wherein the means for sending a response is an output section of the link analysis server.

28. The system of claim 17, further comprising a data persistence section of the link analysis server for storing response results.

29. A software method in a computer system for automatically analyzing relationships between target and source documents, comprising the steps of:
receiving an autolink command by a link analysis server from a requesting application designating a processing profile, target documents and source documents;
accessing the processing profile from a database;
accessing similarity scores between attributes of the target documents and attributes of the source documents from a similarity search server;
linking target document attributes and source document attributes within the link analysis server based on comparative values of attribute similarity scores;
sending results of the linking step to the requesting application; and
saving the results in a persistence database.

30. The method of claim 29, wherein the processing profile is embedded inline in the autolink command.

31. The method of claim 29, wherein the target document attributes and associated schema are embedded inline in the autolink command.

32. The method of claim 29, wherein the source document attributes and associated schema are embedded inline in the autolink command.
